(19) United States
(12) Patent Application Publication
(10) Pub. No.: US 2009/0219795 A1
(43) Pub. Date: Sep. 3, 2009

(54) Optical Head and Optical Disk Drive

(76) Inventor: Yutaka Yamanaka, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/083,639

(22) PCT Filed: Oct. 11, 2006
(86) PCT No.: PCT/JP2006/320308

§ 371 Date: Apr. 16, 2008

(30) Foreign Application Priority Data
Oct. 17, 2005 (JP) 2005-301142
Aug. 3, 2006 (JP) 2006-211542

(51) Int. Cl. G11B 7/00; G11B 20/00

(52) U.S. Cl. 369/47.15; 369/100; G9B/7; G9B/20

(57) ABSTRACT

An optical head reduces, upon signal reproducing from a recording layer of an optical disc (14) including two recording layers (15, 16), the influence incurred by the other recording layer, thereby detecting a stable signal light. A phase modulation member (13) that provides an uneven phase change or a phase changes different by 180 degrees from each other is provided in an area of a condensing lens (11) in the vicinity of the center of the section of the reflecting beam. The phase modulation member (13) cancels a cross-talk light from the other recording layer based on the phase difference thereof, thereby attenuating the cross-talk light incident onto a photodetector (12) to suppress an interference with the signal light.

### FIELD OF THE INVENTION

The present invention relates to an optical disc drive for recording or reproducing data by means of a minute optical spot, and an optical head for use in the optical disc drive.

### BACKGROUND ART

In the field of the optical discs that perform recording/reproducing data by means of a minute optical spot, there have been wide-spread of ROM (Read Only Memory) medium, on which an emboss-like data pit train is formed for allowing reproduction only, followed by prevalence of CD-R (Compact Disc-Recordable) and DVD-R (Digital Versatile Disc-Recordable), which allow recording of data in addition. Optical discs referred to as CD-RW (CD-ReWritable) and DVD-RW (DVD-ReWritable) have appeared on the market. Further, as a next-generation DVD, a standard referred to as HD DVD that uses a blue light source is also issued.

Recently, among those optical discs as described above, an optical disc is developed and produced commercially which achieves a larger recording capacity by forming two recording layers that receive light from the same substrate-incident-surface for recording or reproducing data. As a type of the DVD-ROM, an optical disc including two recording layers is released for use in a long-time movie etc. Also as the DVD-R, a medium including two recording layers is standardized and has become used. Similarly, the standard of the two recording layers has also been set for the next-generation HD DVD. However, since the spacing between the two layers is smaller than that of the DVD, it is necessary to solve a new problem involved therein.

FIG. 6 is a sectional view schematically showing the problem as described above. In the optical disc 14, a zero-th layer 16 and a first layer 15 which are accessible from the same incident surface side are formed as the recording layers. FIG. 6 shows the behavior of the optical beam irradiated from an optical head in the case where the optical beam accesses each of the recording layers 16 and 15. In the drawing, an optical system from the laser light source is omitted for depiction, and the path of a reflected light from the optical disc 14 to a photodetector 12 is depicted. If a condensed spot is formed on the first layer 15 as shown in the left-hand side in the drawing, the signal light to be reproduced is received by the photodetector 12 via an objective lens 17 and a convergent lens 11 while traveling along the optical path shown by a solid line. On the other hand, there occurs another reflected light from the adjacent zero-th layer 16, and part of this light is received by the photodetector 12 after traveling along the optical path depicted by a dotted line. This is referred to as a cross-talk light in the following description. It is shown that the cross-talk light forms an optical path having a virtual focal point at a position nearer to the objective lens 17 by a distance twice the layer spacing as compared to the reflected light from the condensed spot 5, formed on the first layer 15.

On the other hand, as shown in the right-hand side in FIG. 6, when a condensed spot is formed on the zero-th layer 16, a cross-talk light occurs from the first layer 15 simultaneously with the signal light from the zero-th layer 16. In this case, there occurs an optical path having a virtual focal point at a position further from the objective lens by a distance twice the layer spacing as compared to the reflected light from the condensed spot.

It is assumed here that the photodetector 12 is disposed in the vicinity of the position of the condensed spot of the signal light generated by the objective lens 17. In this case, the ratio (received light ratio) of the amount of light received by the photodetector 12 among the cross-talk light from the adjacent layer to the amount of the received signal is almost the same order irrespective of the case where which of the layers is accessed. Here, if the layer spacing is being reduced, the virtual focal point of the cross-talk light approaches the condensed spot of the signal light, whereby the difference between both the optical paths is reduced. As a result the beam diameter of the cross-talk light is reduced on the photodetector, and thus the received light ratio of the cross-talk light is relatively increased.

When the cross-talk light is received, not only the DC component of the received signal light increases, but also the fluctuation component thereof also occurs. This is because outputs from a single laser light source return from the reflecting surfaces along different travel distances having therebetween a difference corresponding to the layer spacing, and the outputs are overlapped each other on the photodetector 12 to generate an optical interference caused by the difference in the travel distance. If the layer spacing does not vary, the condition of the interference is based on the constant difference in the travel distance. However, since the layer spacing varies delicately with the location in an actual optical disc, the condition of the interference varies when the condensed spot moves along the track direction. For example, if the phase difference between the two interfering reflected lights varies from zero to π, that is, if the optical length of the layer spacing which provides the distance difference varies by an amount of ¼ wavelength, the interference condition changes from a condition under which the outputs intensify each other most strongly to a condition under which the outputs weaken each other most strongly. Assuming that the amount of the received signal light and the amount of the received cross-talk are Is and IC, respectively, the total amount of received light changes from Is+Ic to Is−Ic. It is to be noted that Is and Ic are the quantity representing the electric field intensity of the received light, and that the received power is a quantity proportional to the square thereof. It is a matter of course that the signal light and the cross-talk light do not completely overlap each other in the receiving area of the photodetector, and that the phase of each light within the section thereof is not uniform and may involve a disorder, and thus the above case is the worst condition.

If there is a larger amount of received cross-talk light, the DC component of the received light of the photodetector changes with a movement of the optical spot along the track direction, as shown in FIG. 3A, for example, due to the phenomenon as described above, It is revealed that the practical range of variation in the layer spacing in an optical disc causes occurring of a fluctuation component ranging between several kilohertz and several tens of kilohertz in the received light, assuming that the linear velocity of the track direction is around 6 m/second. This is a major factor that degrades the signal characteristic during reproduction of an information signal.

In the conventional two-layer medium having a larger layer spacing, since the amount of received cross-talk light is small, the range of variation can be neglected even if variation occurs in the interference. However, along with a reduction in the layer spacing, the degradation in the reproducing characteristic causes a problem that is hardly neglected. FIG. 7 is graph showing the experimental measurement of the change of amount of the received cross-talk light versus the change of layer spacing. The objective lens used herein had a NA of 0.65. The amount of light above which the data reproduced from a signal light involves a significant information reproduction error is referred to as an allowable amount of cross-talk light, and the allowable amount of cross-talk light is around 10% of the amount of the received signal light, for example. It was revealed that if the layer spacing between the two recording layers is around 40 micrometers, the cross-talk light may exceed the allowable amount of cross-talk light, and the influence by the cross-talk light markedly appears below this spacing. If the NA of the objective lens is smaller than 0.65, the amount of received cross-talk light tends to increase further.

The influence may be critical if the condensed spot is formed from a sub-beam in the optical system, beside a condensed spot formed from a main beam used for recording/reproducing, the sub-beam having a light intensity lower than that of the main beam, and the sub-beam is used for detecting a servo signal such as a tracking error signal. In a typical optical system including the sub-beam, the laser light from the light source is divided by a diffraction grating etc., to form a single main beam and two or more sub-beams. In the recording layer of the optical disc, the sub-beams form a low-intensity spot in the vicinity of and separately from the spot formed by the main beam. Similarly, in the photodetector, the sub-beams are received by another light receiving part provided in the vicinity of the light receiving part that receives the main beam.

Usually, the power intensity of the sub-beams is set at around tenth or lower than the power intensity of the main beam. Accordingly, the ratio of intensity of the reflected light of the main beam reflected by the other recording layer to the intensity of the sub-beams is as large as twice or more times (namely, root of 10 times) relative to the interference to the signal light of the main beam, even in terms of the ratio of the electric field intensity. In addition, in the case where a deviation of the beam distribution within the section of the received light beam is to be detected, as in the case of a push-pull signal, the variation may occur only in the push-pull signal, if the interference occurs partially and unevenly irrespective of a small range of variation in the total amount of the received light. If the NA is as high as 0.85, such a problem may occur even if the system has a smaller cross-talk light.

A literature “International Symposium on Optical Memory 2004, Technical Digest, Th-I-06, “BD Pickup Head for Dual Layer Disc”, for example, describes a conventional technique for preventing the above cross-talk light. In the literature, part of the light in the beam section of the reflected light is diffracted by a diffraction element toward the direction away from the light reception, to thereby perform an equivalent shading effect and prevent the cross-talk light from reaching the photodetector. However, in this technique, since part of the signal light in addition to the cross-talk light is shaded and thus impossible to receive, there is a problem in that the signal itself is deteriorated.

### DISCLOSURE OF THE INVENTION

It is an object of the present invention to provide an optical head and an optical disc drive, which are capable of reducing the ratio of the amount of received cross-talk light generated from the optical disc including two or more recording layers to the amount of the received signal light and thus having an improved data reproducing performance.

The present invention provides, in a first aspect thereof, an optical head that condenses a light from a light source onto a recording layer of an optical disc and includes a photodetector for receiving a reflected light from the recording layer as a signal light, the optical head including: a phase modulation plate disposed in an area in a vicinity of a center of an optical beam section of the signal light, the area passing therethrough a part of the reflected light overlapping the signal light on the photodetector among the reflected light reflected from a position in a vicinity of the recording layer as viewed along an optical axis, the phase modulation plate including a plurality of areas that provide different phase changes to a light passing through the phase modulation plate.

The present invention provides, in a second aspect thereof, an optical head that condenses a light from a light source onto a recording layer of an optical disc and includes a photodetector for receiving a reflected light from the recording layer as a signal light, wherein: condensed spots including a main beam and a plurality of sub-beams having an intensity lower than an intensity of the main beam are formed on the recording layer in the optical disc; and the optical head further includes a phase modulation plate disposed in an area in a vicinity of a center of an optical beam section of the signal light generated from the main beam, the area passing therethrough a part of the reflected light overlapping the signal light from the sub-beam on the photodetector among the reflected light reflected from a position in a vicinity of the recording layer as viewed along an optical axis, the phase modulation plate including a plurality of areas that provide different phase changes to a light passing through the phase modulation plate.

The present invention provides, in a third aspect thereof, an optical disc drive including an optical head that condenses a light from a light source onto a recording layer of an optical disc and includes: a photodetector for receiving a reflected light from the recording layer as a signal light; and a signal reproduction unit for reproducing data recorded on the recording layer from the signal light received by the photodetector, wherein: the optical head includes a phase modulation plate disposed in an area in a vicinity of a center of an optical beam section of the signal light, the area passing therethrough a part of the reflected light overlapping the signal light on the photodetector among the reflected light reflected from a position in a vicinity of the recording layer as viewed along an optical axis, the phase modulation plate providing different phase changes to a light passing through the phase modulation plate.

The present invention provides, in a fourth aspect thereof, an optical disc drive including: an optical head that condenses a light from a light source onto a recording layer of an optical disc and includes a photodetector for receiving a reflected light from a recording layer as a signal light; and a signal reproduction unit for reproducing data recorded on the recording layer from the signal light received by the photodetector, wherein: condensed spots including a main beam and a plurality of sub-beams having an intensity lower than an intensity of the main beam are formed on the recording layer in the optical disc; the optical head further includes a phase modulation plate disposed in an area in a vicinity of a center of an optical beam section of the signal light from the main beam, the area passing therethrough a part of the reflected light overlapping the signal light from the sub-beam on the photodetector among the reflected light reflected from a position in a vicinity of the recording layer as viewed along an optical axis, the phase modulation plate providing different phase changes to a light passing through the phase modulation plate.

In accordance with the optical head and optical disc drive of the present invention, since the two areas of the phase modulation plate provides different phase changes to the reflected light configuring the cross-talk light passing through the phase modulation, the transmitted lights passed by the respective areas cancel each other due to the phase change provided thereto. The ratio of part of the reflected light passed by the phase modulation plate among the signal light received by the photodetector to the total signal light is smaller than the ratio of the part of the cross-talk light passed by the phase modulation plate among the cross-talk light received by the photodetector to the total cross-talk. Accordingly, the ratio of the cross-talk light received by the light receiving part to the signal light is reduced, whereby the data reproduced from the signal light has an improved reliability.

### BRIEF DESCRIPTION OF THE DRAWINGS

FIG. 1 is a perspective view exemplifying the basic configuration of an optical system in an optical head according to an embodiment of a the present invention.

FIG. 2 is a schematic sectional view showing the relationship between the recording layer of the optical disc and the reflected light.

FIGS. 4A and 4B are a graph showing the signal light received by the photodetector and varying due to the cross-talk light modulated in each area of the phase modulation member.

FIGS. 4A and 4B are a top plan views showing each area of the phase modulation member.

FIG. 5 is a block diagram of an optical head according to an embodiment of the present invention.

FIG. 6 is a schematic sectional view showing the behavior of a reflected light in a conventional optical head.

FIG. 7 is a graph showing the relationship between the layer spacing of the recording layers and the amount of the received cross-talk light.

FIG. 8 is a block diagram of an optical disc drive according to an embodiment of the present invention.

FIG. 9B is a top plan view showing the pattern of a photodetector in the case of using a three-beam technique, and FIG. 9B is a top plan view showing a phase modulation member in this case.

### BEST MODE FOR CARRYING OUT THE INVENTION

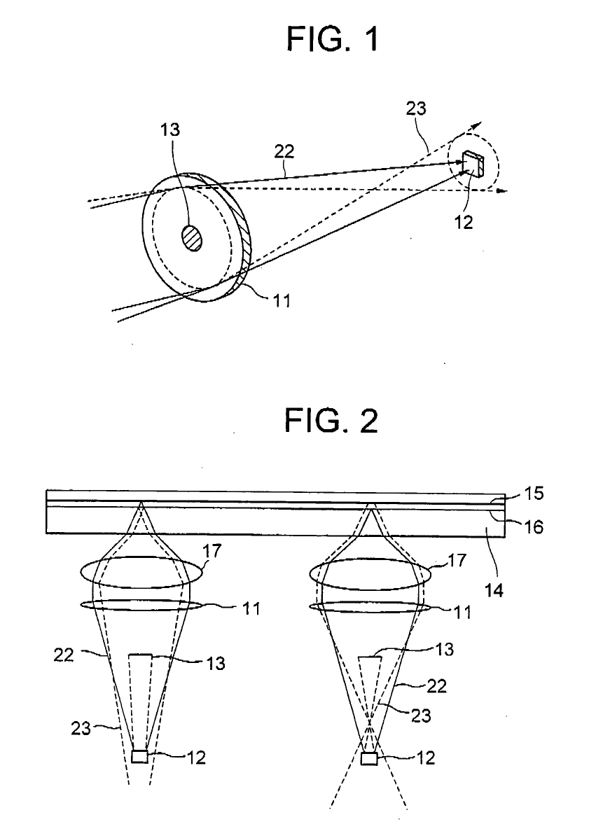

Hereinafter, an optical head and an optical disc drive according to embodiments of the present invention will be described with reference to the accompanying drawings. FIG. 1 is a perspective view exemplifying the basic configuration of an optical system for receiving the signal light in the optical head of an embodiment of the present invention. A signal light 22 from one of two recording layers in an optical disc including the two recording layers not shown in the figure is condensed by a convergent lens 11 to be received by a photodetector 12. On the other hand, the cross-talk light from the adjacent recording layer configures a light beam having a larger diameter compared to the signal light 22, because the location of the condensed spot thereof is deviated as viewed along the optical axis, and part of the cross-talk light is received on the photodetector 12.

At this stage, a substantially central part of the cross-talk light 23 within the beam section thereof is received while overlapping the signal light 22. A phase modulation member 13 is provided in the central part of the convergent lens 11 through which the part of the cross-talk light 23 thus overlapping passes.

FIG. 2 is a sectional view showing the detail of the path of the signal light 22 and cross-talk light 23 passing through the objective lens 17, convergent lens 11 and phase modulation member 13 toward the photodetector 12, in the case of the optical disc having two recording layers including a first layer 15 and a zero-th layer 16. In the left-hand side in FIG. 2 wherein a condensed spot is formed on the first layer 15, the reflected light from the first layer 15 configures the signal light 22, whereas the reflected light from the zero-th layer 16 configures the cross-talk light 23. In the right-hand side in FIG. 2 wherein a condensed spot is formed on the zero-th layer 16, the reflected light from the zero-th layer configures the signal light 22, whereas the reflected light from the first layer 15 configures the cross-talk light 23.

In either case of FIG. 2, the part of the cross-talk light 23 overlapping the signal light 22 on the photodetector 12 passes through the phase modulation member 13 in the substantially same manner. It will be understood from the figure that if the phase modulation member 13 is installed in the vicinity of the convergent lens 11 as viewed along the optical axis, a similar effect can be obtained in both the cases of the figure.

The phase modulation member 13 generates an uneven phase change within the section of the transmitted light. For example, the phase modulation member 13 allows the light to pass therethrough without any phase change in a first area which occupies a half area of the phase modulation member 13, whereas the phase modulation member 13 allows the light to pass therethrough with a phase change of π in a second area which occupies the other half area thereof.

FIGS. 3A and 3B show the intensity of the received light received by the photodetector 12 as a function of the location in the track direction corresponding to the rotation of the optical disc, as a result of the interference by the cross-talk light passed by the first area and second area of the phase modulation member 13, for the case of the reflected light shown in FIG. 2. FIG. 3A shows that the total received light signal received by the photodetector 12 fluctuates as shown in the figure, as a result of the interference by the cross-talk light which passed through the first area without any phase change thereof. FIG. 313 shows a received signal having a fluctuation phase inverted from that of FIG. 3A as a result of the interference by the cross-talk light which passed through the second area with a phase change of π. Based on the fluctuation phase shown in FIGS. 3A and 3B, reception of both the reflected lights at an equal amount and at the same time will allow cancellation of the fluctuation component. If both the areas have different dimensions or the phase difference between both the areas deviates from π, the cancellation of the cross-talk light will be insufficient. However, if such an insufficient cancellation can reduce the fluctuation of the received light down to half or less, for example, a sufficient effect is obtained on the suppression of degradation of the reproduced signal.

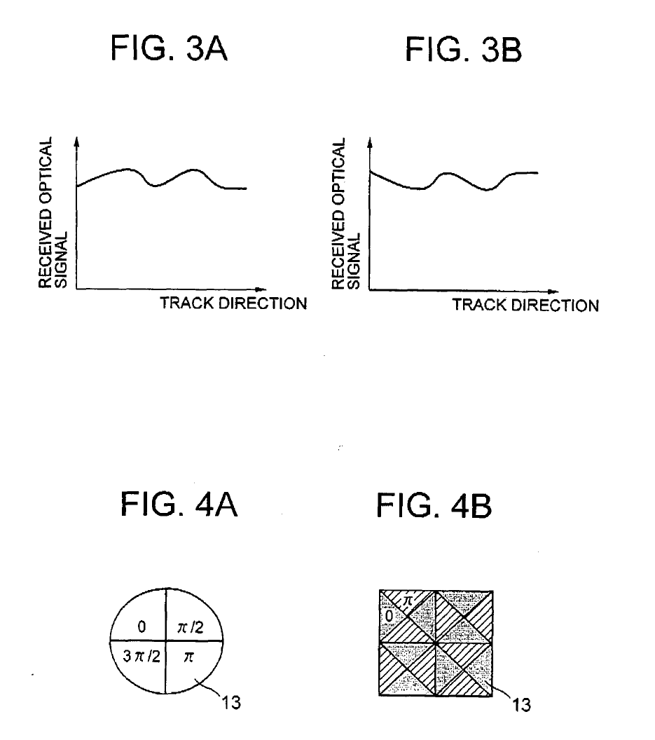

It is sufficient for the phase modulation member 13 to generate a phase difference between or among a plurality of areas. However, it is preferred that the cross-talk lights passed by the phase modulation member 13 cancel each other by 100% as a whole. For example, a phase difference of 0, π/2, 3π/2, and π may be allocated to respective four areas of the phase modulation member 13, as shown in FIG. 4A. In an alternative, two types of phase difference, 0 and π, may be allocated to a plurality of areas, as shown in FIG. 4B. Allocation of each of a plurality of phase differences to a plurality of areas, as used in the latter case, may provide an advantage that the influence by the phase difference can be suppressed even in the case where the cross-talk light and/or the signal light inherently include a phase difference in the beam section thereof.

The phase modulation member 13 provides a phase change to the cross-talk light as well as the signal light passing therethrough. However, if a substantially whole of the signal light is received, the spot size on the photodetector 12 may be expanded to some extent, because the phase change provided by the phase modulation member 13 is only a phase change of a part of the beam section. Thus, if the output of the light receiving part of the photodetector 12 has a margin, the change of the received signal light is scarcely observed.

The phase difference in the phase modulation member 13 can be easily achieved as by attaching coated films having different thicknesses to a convergent lens, by diffracting whole the light beam while deviating the phase of the part of the diffraction element used therein.

The advantage of providing the phase modulation member 13 to control fluctuation of the received light signal depends on the received amount of the cross-talk light. This advantage is particularly effective in the case where the layer spacing between the recording layers is smaller than 40 micrometers, and where the NA of the optical system is smaller than 0.65.

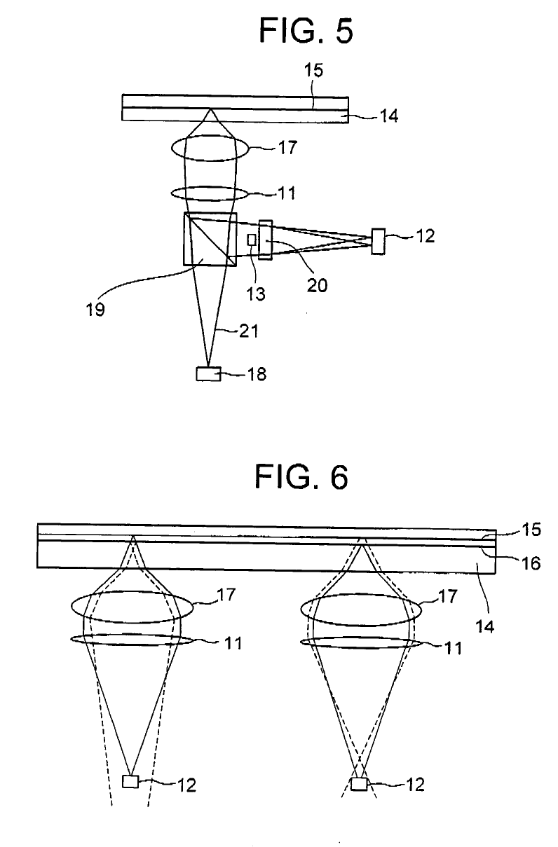

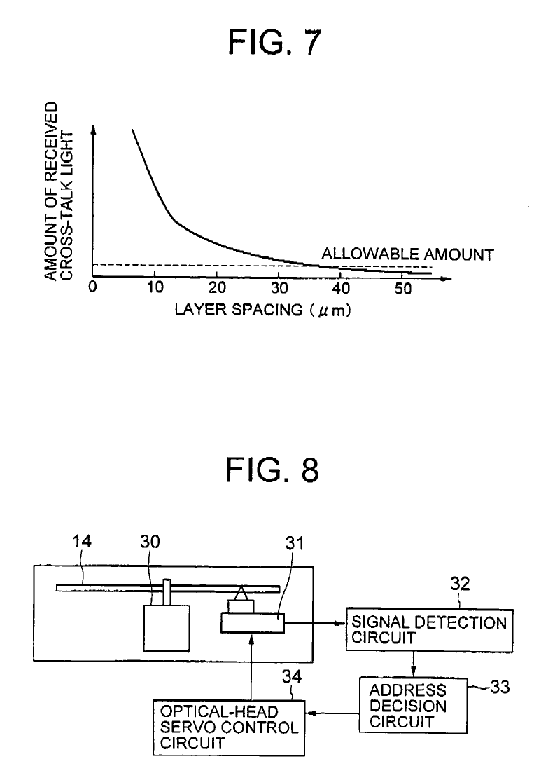

FIG. 5 shows an optical head according to an embodiment of the present invention. The emitted light 21 from a laser light source 18 is condensed on the recording layer 15 of the optical disc 14 via a beam splitter 19, a convergent lens 11, and an objective lens 17. The reflected light from the optical disc 14 is reflected by the beam splitter 19 and received by a photodetector 12 via a phase modulation member 13 and a cylindrical lens 20.

In the optical head of FIG. 5, the configuration shown in FIG. 4A wherein the total area of the photodetector 12 is divided into four areas, for example, may be preferably employed. The quadrisected configuration of the photodetector 12 allows a focus error signal to be detected using an astigmatic technique, and allows a tracking error signal to be detected using a push-pull technique or a phase-difference detection technique.

In addition to the above techniques, the optical head of the present invention may be combined with a configuration which adopts the well-known knife edge technique or three-beam technique, and may be applied to an optical head of an interchangeability type adapted to a plurality of standards of the optical disc.

If condensed spots including those of a main beam and two or more sub-beams are formed on an optical disc and a servo tracking error signal is to be detected from the sub-beams, as in the case of the three-beam technique, it is necessary to take into consideration the influence by the interference in the sub-beams to a higher degree than the in the main beam. This is because the sub-beams have an intensity smaller than the intensity of the main beam, and accordingly are liable to the influence of the interference by the cross-talk light.

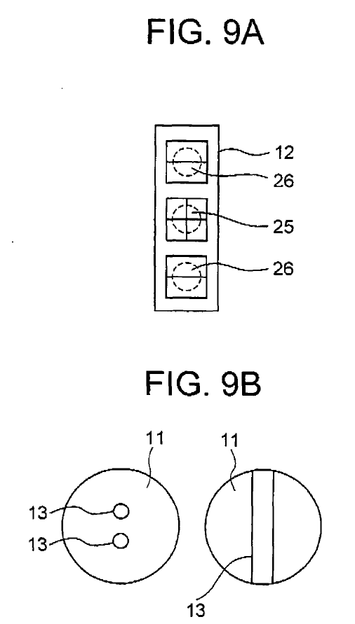

FIG. 9A shows an example of the received light pattern of the photodetector 12 in the case of using the three-beam technique. There are provided a quadrisected light receiving part located at the center for receiving the main beam 25 and bisected light receiving parts located at the top and bottom in the drawing for receiving the two sub-beams 26. FIG. 9B shows an example of the setting on the surface of the convergent lens 11 of the phase modulation member 13 corresponding to such a received light pattern. The left-hand side shows an example in which the phase modulation member 13 is provided only at the portion passed by the cross-talk light overlapping the sub-beam-light receiving parts, whereas the right-hand side shows an example in which the phase modulation member 13 is provided so that the phase modulation member 13 covers all the parts receiving the sub-beams and main beam. In the example of the right-hand side, the phase modulation member 13 requires a positional adjustment only in the lateral direction, thereby providing the advantage of a larger allowable margin for the installed position.

If the light receiving part is divided into a plurality of areas, as shown in FIG. 9, there is a technique which should be taken into consideration for the setting of the phase modulation member, not only for the case of using a plurality of beams. It is the fine setting of the pattern of the phase modulation member, so as to allow the respective light receiving parts to cancel therein the phase caused by the interference. Consideration of such a setting allows dealing with the light receiving parts having any partitioned pattern.

It is a matter of course that if the number of sub-beams is increased up to three or more, such a configuration may be dealt with by providing the phase modulation members at the corresponding positions of the respective reflected light beams similarly to the above case. In addition, it is also possible to provide the phase modulation member only for a single sub-beam subjected to the marked influence by the cross-talk light, without providing the phase modulation member in the other sub-beam or sub-beams.

The configuration of the optical head of the present invention may be applied to any type of the optical head so long as the optical head includes an optical system including the phase modulation member at the position through which the cross-talk light interfering the signal light passes. In addition, the optical disc reproduced by the optical head of the present invention may be any optical disc including two or more recording layers, and any multilayer optical disc including three or more layers.

FIG. 8 is a block diagram showing an optical disc drive according to an embodiment of the present invention. The optical head 31 performs recording or reproducing operation onto the optical disc 14 having multiple recording layers and set on a spindle 30. The optical head 31 may be the optical head described with reference to FIG. 5, which incorporates therein the optical system that controls interference by the cross-talk light.

The signal from the optical head 31 is reproduced by a signal detection circuit 32, wherein the address signal is taken out simultaneously with the recorded information, to be delivered to the address decision circuit 33. The address decision circuit 33 judges the address position of the present optical head, to provide the present address position to the optical-head servo control circuit 34. The optical-head servo control circuit 34 performs servo control of the optical head 31 based on the difference between the present address position and the address position to be accessed, and locates the condensed spot at the desired address on the desired recording layer among the multiple recording layers.

Each recording layer of the optical disc includes an organic-material film, a dielectric film, a metallic reflection film etc. If the number of the recording layers is two, the movement of the condensed position of the optical spot between the layers can be performed with ease. If the number of recording layers is three or more, and a spherical aberration occurs depending on the condensed position, it is preferred to provide a compensation optical system in the optical system of the optical head 31.

As described heretofore, the optical head and optical disc drive of the present invention may have the following configurations. The phase modulation plate includes a plurality of groups of areas, the groups each providing different phases to the light passing through the phase modulation plate. The group of areas providing different phases allows the cross-talk signals to cancel each other, and the plurality of groups of the areas suppress the influence by the phase fluctuation inherently included in the signal light etc.

It is also a desirable embodiment wherein the groups each include at least two areas that provide different phases having a difference therebetween 180 degrees to the light passing through the phase modulation plate. In this case, the lights passed by both the areas have therebetween a phase difference of 180 degrees from each other, thereby achieving a complete cancellation.

The optical head and optical disc drive of the present invention are preferably used in the case where the optical disk includes two recording layers, and the optical head irradiates a laser light onto both the recording layers from one side of the optical disc. In this case, the amount of cross-talk light generated from both the recording layers is particularly reduced.

The present invention achieves a particularly remarkable advantage in the case where the layer spacing between the two recording layers is smaller than 40 micrometers, and the objective lens of the optical head has an NA of 0.65 or below. In this case, the ratio of the amount of the cross-talk signal to the amount of the signal light can be reduced down to 10% or less.

While the invention has been described with reference to preferred embodiments thereof, the optical head and optical disc drive of the present invention are not limited to the above embodiments, and modifications and alterations made from the above embodiments may fall within the scope of the present invention.

1. (canceled)

2. (canceled)

3. (canceled)

4. (canceled)

5. (canceled)

6. (canceled)

7. (canceled)

8. (canceled)

9. An optical head, comprising:
a light source for irradiating an incident light onto one of a plurality of recording layers in an optical disk;
a photodetector for detecting a signal light reflected from the one of the recording layers; and
a phase modulation member disposed in an area in a vicinity of a center of an optical beam section of the signal light, the area passing therethrough a part of a reflected light overlapping the signal light on the photodetector, the reflected light being reflected from a position in a vicinity of the one of the recording layers as viewed along an optical axis, the phase modulation member including a plurality of areas that provide different phase changes to a light passing through the phase modulation member.

10. The optical head according to claim 9, wherein the phase modulation member includes a plurality of groups of areas, the groups each providing different phase changes to the light passing through the phase modulation member.

11. The optical head according to claim 10, wherein the groups each include at least two areas that provide different phase changes having a difference therebetween 180 degrees to the light passing through the phase modulation member.

12. The optical head according to claim 9, wherein the optical disk includes two recording layers, and the position disposed in the vicinity along the optical axis and generating the reflected light is at the other of the two recording layers.

13. The optical head according to claim 12, wherein the two recording layers have therebetween a layer spacing of smaller than 40 micrometers, and an objective lens of the optical head has an NA of 0.65 or below.

14. An optical head, comprising:
a light source for irradiating a main beam and a plurality of sub-beams having an intensity lower than an intensity of the main beam, to form condensed spots onto one of a plurality of recording layers in an optical disk;
a photodetector for detecting a signal light reflected from each of the condensed spots on the one of the recording layers; and
a phase modulation member disposed in an area in a vicinity of a center of an optical beam section of the signal light generated from the main beam, the area passing therethrough a part of a reflected light overlapping the signal light generated from one of the sub-beams on the photodetector, the reflected light being reflected from a position in a vicinity of the one of the recording layers as viewed along an optical axis, the phase modulation member including a plurality of areas that provide different phase changes to a light passing through the phase modulation member.

15. The optical head according to claim 14, wherein the phase modulation member includes a plurality of groups of areas, the groups each providing different phase changes to the light passing through the phase modulation member.

16. The optical head according to claim 15, wherein the groups each include at least two areas that provide different phase changes having a difference therebetween 180 degrees to the light passing through the phase modulation member.

17. The optical head according to claim 15, wherein the optical disk includes two recording layers, and the position disposed in the vicinity along the optical axis and generating the reflected light is at the other of the two recording layers.

18. The optical head according to claim 17, wherein the two recording layers have therebetween a layer spacing of smaller than 40 micrometers, and an objective lens of the optical head has an NA of 0.65 or below.

19. An optical disc drive, comprising:
an optical head comprising a light source for irradiating an incident light onto one of a plurality of recording layers in a optical disk, a photodetector for detecting a signal light reflected from the one of the recording layers, and a phase modulation member disposed in an area in a vicinity of a center of an optical beam section of the signal light, the area passing therethrough a part of a reflected light overlapping the signal light on the photodetector, the reflected light being reflected from a position in a vicinity of the one of the recording layers as viewed along an optical axis, the phase modulation member including a plurality of areas that provide different phase changes to a light passing through the phase modulation member; and
a signal reproduction unit for reproducing data recorded on the one of the recording layers from the signal light received by the photodetector.

20. An optical disc drive, comprising:
an optical head comprising a light source for irradiating a main beam and a plurality of sub-beams having an intensity lower than an intensity of the main beam, to form condensed spots onto an optical disk including a plurality of recording layers, a photodetector for detecting a signal light reflected from each of the condensed spots on one of the recording layers, and a phase modulation member disposed in an area in a vicinity of a center of an optical beam section of the signal light generated from the main beam, the area passing therethrough a part of a reflected light overlapping the signal light generated from one of the sub-beams on the photodetector, the reflected light being reflected from a position in a vicinity of the one of the recording layers as viewed along an optical axis, the phase modulation member including a plurality of areas that provide different phase changes to a light passing through the phase modulation member; and
a signal reproduction unit for reproducing data recorded on the one of the recording layers from the signal light from the main beam received by the photodetector.
